(19) United States
(12) Patent Application Publication
(10) Pub. No.: US 2008/0289695 A1
(43) Pub. Date: Nov. 27, 2008

(54) Heat activated automatic gas shut-off valve

(76) Inventors: Robert C. Holzer, Orofino, ID (US); Thomas C. Gray, Clarkston, WA (US)

Correspondence Address: Frederick Gotha, Esq.;Suite 823, 80 South Lake Avenue, Pasadena, CA, 91101, US

(21) Appl. No.: 11/805,095

(22) Filed: May 21, 2007

(51) Int. Cl. F16K 17/40

(52) U.S. Cl. 137/73; 137/75

(57) ABSTRACT

This invention relates to a heat activated shut-off device for gas and liquid flows in fuel supply lines and consists of a housing with a longitudinal void therethrough for fluid passage. A valve seat within the longitudinal void and a spring biased piston slidably carried within the housing when in bearing engagement, will shut-off the flow of fluid. A eutectic metal fuse which is temperature sensitive and fails at a pre-determined temperature extends in part externally of the external surface of the housing and couples with a flow indicator carried adjacent the housing external surface. Coupling of the eutectic metal fuse and flow indicator exposes the eutectic metal fuse at least in part to ambient air. The flow indicator is rotatable upon displacement of the piston. Failure of the eutectic metal fuse results in the uncoupling of the flow indicator that permits the spring to displace the piston into the valve and consequently rotate the flow indicator to another position thereby evidencing shut-off.

This application claims priority from U.S. Provisional Application No. 66/802,139, filed on May 22, 2006.

### FIELD OF THE INVENTION

This invention relates to heat activated shut-off valves for gas and liquid fluid flows.

### BACKGROUND OF THE INVENTION

When attachment fittings for water heaters, clothes dryers, gas burning stoves, and other devices that utilize propane, natural gas, or heating oil as energy sources, under extreme heat conditions fail, the escaping fuel supply will ignite and escalate the fire hazard to the immediate environment. The intensity of heat, such as, for example, that generated by wild fires or forest fires will have a destructive effect on such attachment fittings and consequently propane gas lines, natural gas lines, and heating oil lines will become delivery sources of fuel to feed a fire unless immediately shut-off. Shut-off valves to stop the flow of fuel which utilize a eutectic metal fuse that fails at a predetermined temperature are known in prior art. The eutectic metal fuse, however, is so disposed within the housing of the valve that the heat must first flow through the housing wall in order to raise the temperature of the eutectic metal fuse resulting in a delay of mechanical failure of the fuse and consequently a delay in shutting off fuel flow.

It is therefore desirable to accelerate fuel flow shut-off before the attachment fittings fail and to have visual confirmation thereof, particularly in locations that have exposure to forest fires or wild fires. To achieve such a result, a fluid or gas shut-off valve that utilizes a eutectic metal fuse which is directly exposed to ambient air externally of the housing will reach a failure temperature through heat radiation more rapidly and consequently the time to actuate valve closure within the fuel line is accelerated. A valve design having a eutectic metal fuse that mechanically fails from direct radiation rather than from heat flow conducted through a housing body would accelerate the interruption and stoppage of fuel flow and therefore minimize the fire hazard.

### SUMMARY OF THE INVENTION

There is therefore, provided according to the present invention, a heat activated fluid flow shut-off valve that is actuated by the failure of a eutectic metal fuse member extending in part through the surface of the valve housing and into the body of the valve housing and extending in part within a flow indicator member carried externally of the housing. Failure of the eutectic member permits a piston, which is responsive to the force exerted by an expanding spring, to be axially displaced in a downstream direction and bearingly engage a valve seat thereby stopping fluid flow. An actuation arm integrally carried by the piston extends through the valve seat and applies a torque upon axial displacement of the piston to a pivot shaft mounted for rotation with respect to the housing. The pivot shaft carries the flow indicator member in fixed rotational relationship where the flow indicator member is carried externally of the housing. Axial displacement of the actuation arm therefore results in a torque applied to the pivot shaft thereby rotating the pivot shaft and flow indicator member to a second position. The second position of the flow indicator member provides visual evidence that the valve was activated and fluid flow stopped.

The present invention is directed to a shut-off valve that consists of a housing that has a longitudinal axis, an upstream end, a downstream end, and an axially extending void through the housing which permits fluid to flow through the housing. The term fluid as used herein shall mean gas or liquid. A pivot shaft is carried by the housing intermediate the upstream and downstream ends of the housing and has a vertical axis extending laterally of the longitudinal axis of the housing. The pivot shaft has first and second ends where the first end extends externally of the housing and the shaft is so adapted to and carried by the housing so as to permit angular rotation of the pivot shaft with respect to its vertical axis. A flow indicator member is removably mountable to the first end of the pivot shaft and is so adapted such that the flow indicator member after mounting may be in fixed rotational relationship with the pivot shaft.

A valve seat and piston are utilized in shutting off the flow of fluid through the void. The valve seat is located within the housing intermediate the upstream and downstream ends of the housing and the piston is slidably carried within the housing for axial displacement within the void. The piston is so dimensioned and proportioned such that upon bearing engagement with the valve seat, the flow of fluid through the void will be interrupted and stopped. In the preferred embodiment the piston has an actuation arm extending axially through the valve seat for actuating rotation of the pivot shaft during axial displacement of the piston with the valve seat. Bearing engagement of the piston with the valve seat and rotation of the pivot shaft by the actuation arm occur as a result of structural failure in shear of the eutectic metal fuse member that extends in part both into the housing and externally of the housing where it is coupled to a flow indicator member. The eutectic metal member is temperature sensitive and upon reaching a predetermined temperature which is less than the ignition temperature for the fluid will fail structurally permitting the pivot shaft and flow indicator member to rotate.

Rotation of the pivot shaft and flow indicator member, as a result of the failure of the eutectic member at a pre-determined temperature, is achieved through a spring which bears compressively against the piston and housing when compressed. Failure of the eutectic member allows the spring to expand axially and axially displace the piston into the valve seat and thereby axially displace the actuation arm. In the preferred embodiment, the pivot shaft has a chord type slot extending laterally of its vertical axis where the actuation arm before spring actuation is positioned orthogonally to the slot and laterally of the vertical axis such that upon failure of the eutectic metal the actuation arm applies a torque as it extends through the slot causing the pivot shaft to rotate until the actuation arm is aligned axially with the slot. In another embodiment, not shown, rotation of the pivot shaft may be achieved by a rack and pinion relationship between the pivot shaft and actuation arm.

### BRIEF DESCRIPTION OF THE DRAWINGS

These and other features and advantages will become appreciated as the same become better understood with reference to the following specification, claims and drawings wherein:

FIG. 1 is a cross-sectional view of the heat activated fluid flow shut-off valve of this invention illustrating the valve in the open position.

FIG. 2 is a top view of the flow indicator member shown in FIG. 1.

FIG. 3 is a top view of the piston in cross-section illustrating the actuation arm positioned adjacent the pivot shaft, before actuation of the piston.

FIG. 4 is a cross-sectional view of the heat activated fluid flow shut-off valve of this invention illustrating the valve in the closed position.

FIG. 5 is a cross-sectional view taken along the line 5-5.

### DETAILED DESCRIPTION

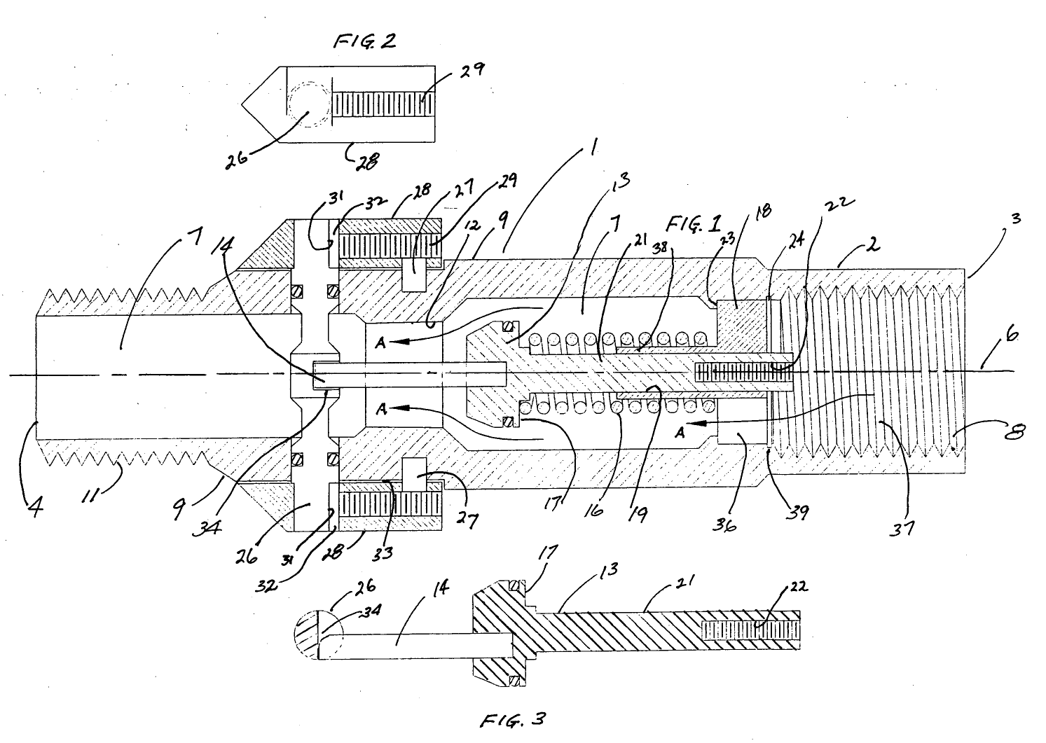

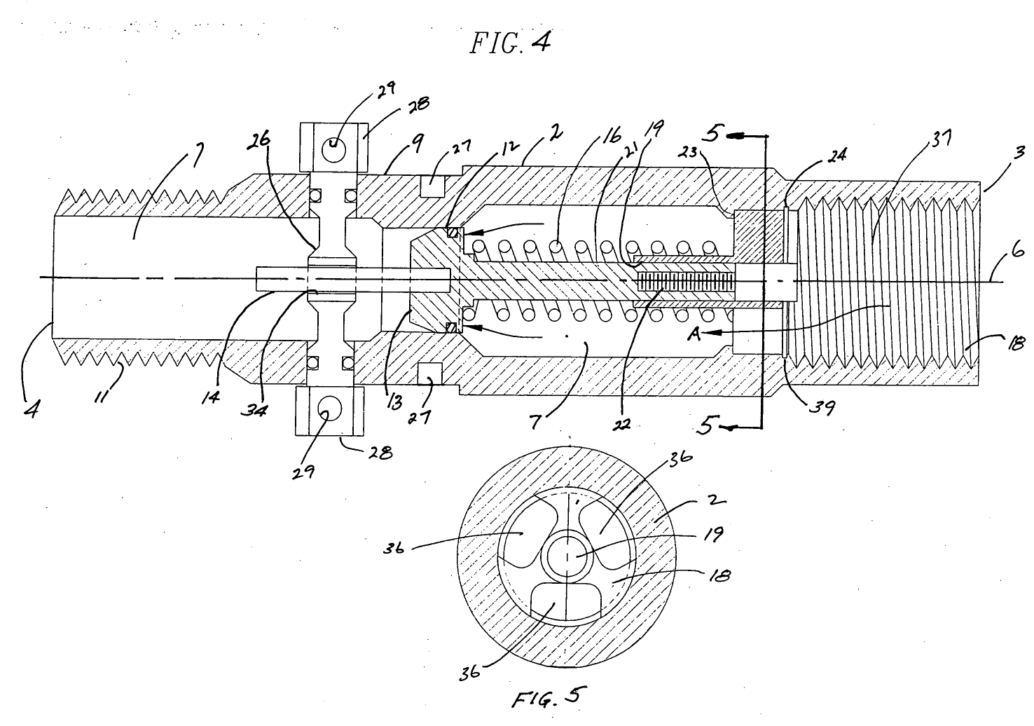

FIG. 1 is a cross-sectional view of the heat activated shut-off valve of this invention in an open position allowing fluid to flow through the device. The shut-off position is shown in FIG. 4 which is also a cross-sectional view where the device has been activated by heat. The shut-off valve is threaded at its upstream and downstream ends so as to permit insertion into a fuel supply line for various types of devices such as water heaters, clothes dryers, gas burning stoves, or other such devices where attachment fittings are likely to fail under intense heat conditions. An example of such condition is a wild fire, chemical fire or wildfire.

Referring to FIG. 1, an assembly of the shut-of valve 1 is illustrated in the open position with fluid flow shown by arrows A through housing 2. Housing 2 has an upstream end 3, a downstream end 4, and a longitudinal axis 6. In the open position, fluid is permitted to flow through void 7 which extends axially through housing 2. As can be seen in FIG. 1, void 7 is in part bounded by internal threads 8 at upstream end 3. At downstream end 4, external surface 9 of the housing 2 contains external threads 11. The internal and external threads 8 and 9 respectively permit assembly 1 to be inserted into a fuel supply line (not shown) that transports the fuel to a working environment. In other embodiments, the device may have external threads at both the upstream and downstream ends. As can further be seen in FIG. 1, void 7 has a valve seat 12 which is a region within void 7 where the internal diameter of the void axially decreases thereby decreasing the cross-sectional area of the void in the downstream direction creating a valve seat. The valve seat 12, upon sufficient axial displacement of the piston, engages piston 13 which has an extension arm 14 extending axially from the piston in a downstream direction where extension arm 14 is carried in fixed relationship with piston 13. Axial displacement of the piston 13 will cause extension arm 14 to be displaced a like amount.

Displacement of extension arm 14 will result in a force transmitted through extension arm 14 to pivot shaft 26 where the arm and shaft are so constructed such that the axial force exerted by extension arm 14 will apply a torque which will be translated into rotation of pivot shaft 26. Axial translation of piston 13 is achieved by expansion of spring 16 which, as shown in both FIGS. 1 and 4, bears compressibly against shoulder 17 of piston 13 and against support guide 18. As can be seen in FIG. 1, support guide 18 has an axially extending opening 19 for receiving in telescopic relationship piston rod 21. Piston rod 21 has internal threads 22 which upon threaded engagement with a threaded male member (not shown) permits spring 16 to be compressed as piston rod 21 is drawn axially through opening 19 of support guide 18 by the threaded male member advancing axially along internal threads 22. Support guide 18 is precluded from upstream or downstream displacement by lip 23 of the housing forming a barrier to further downstream displacement and by snap ring 24 which locks support guide 18 within void 7. The mechanism by which spring 16 is permitted to expand and thereby seat piston 13 into valve seat 12 requires failure at a predetermined temperature of a eutectic metal fuse.

Eutectic alloys are well known in the prior art to provide for sudden mechanical failure at a pre-determined temperature. These types of alloys have a single melting point which is lower than that of the constituent metals forming the alloy. As an example, pure tin melts at 450° F. and pure bismuth at 520° F.; but combined in appropriate proportions can form a eutectic metal fuse which melts at 281° F. if the proportions are 42% tin and 58% bismuth. Thus for the purposes of having a shut-off valve activated by the failure of the alloy, it is preferable to have failure at temperatures well below the ignition temperature of the fuel and below the temperatures at which attachments in the fuel lines of energy driven devices fail. The tensile strength of the eutectic alloy having the proportions above described and a temperature induced structural failure of 281° F. is approximately 8,000 pounds per square inch; the tensile strength for a failure at 255° F. will be approximately 6,400 pounds per square inch. The failure range therefore of a eutectic metal fuse is pre-determined and consequently selectable based upon the anticipated failure of attachments or ignition temperature of fuel.

Referring to FIG. 1, eutectic metal fuse 27 extends through both the external surface of housing 2 and flow indicator member 28. Flow indicator member 28 is removably mountable to pivot shaft 26 by a set screw (not shown) which threads into threaded bore 29 and locks flow indicator member 28 rotationally with pivot shaft 26 when the set screw bears compressibly against the wall 31 of vertical slot 32. There is an air space 33 between the external surface 9 of housing 2 and flow indicator member 28 which permits eutectic metal fuse 27 to be circumferentially exposed to ambient air. Thus, heat is transferred from the ambient air directly to eutectic metal fuse 27 to raise the temperature of the metal at a greater rate than if the fuse were carried internally by the housing.

By referring to FIGS. 1, 3 and 4, the means to interrupt and stop fluid flow by failure of eutectic metal fuse 27 can be appreciated. The position of extension arm 14 before failure is shown to be in compressive engagement with horizontal chord slot 34 which extends laterally of the vertical axis of pivot shaft 26. By referring to FIG. 3, it can be seen that extension arm 14 is positioned laterally of longitudinal axis 6 such that the direction of the force transmitted by axial displacement of extension arm 14 creates a torque about the rotational or vertical axis of pivot shaft 26. Thus, failure of eutectic metal fuse 27 will cause spring 16 to displace axially in a downstream direction thereby rotating pivot shaft 26 until extension arm 14 extends through and is axially aligned with horizontal chord slot 34. So long as extension arm 14 bears compressively against the chord slot a torque will be applied to the pivot shaft 26 and both the pivot shaft and horizontal chord slot 34 will rotate. Passage of the extension arm axially through and aligned with the slot precludes further rotation as piston 13 is urged by spring 16 to compressibly engage valve seat 12 and stop fluid flow as shown in FIG. 4. As described above, flow indicator member 28 is mounted to pivot shaft 26 in fixed rotational relationship and will rotate to a second position indicating that the shut-off valve has been activated.

FIG. 5 is a cross-sectional view along the line 5-5 of FIG. 4 and illustrates the support guide 18 disposed within void 7 in fixed positional relationship with housing 2. The support guide has a multiplicity of open regions 36 which are in fluid communication with void 7 and upstream region 37 of housing 2. To set the shut-off valve for insertion into a fuel line, spring 16 is first positioned to circumferentially engage shank 38 of support guide 18. Piston rod 21 is then inserted axially through spring 16 and into telescopic slidable relationship with support guide opening 19. The assembly of the piston 13 with extension arm 14, spring 16, and support guide 18 is then inserted axially in a downstream direction through the upstream internal region 37 until support guide 18 is precluded from further axial displacement by housing lip 23. Snap ring 24 is thereafter inserted until it expands into circumferential slot 39 thereby fixing the location of the support guide with respect to housing 2.

During the insertion of the above assembly axially through upstream internal region 37, pivot shaft 26 is freely rotatable within housing 2 and extension arm 14 is positioned to extend through horizontal chord slot 34 and in axial alignment therewith. By threading a threaded male member into internal threads 22, spring 16 is compressed between piston shoulder 17 and support guide 19 which results in extension arm 14 being axially displaced in an upstream direction. The first end of eutectic metal fuse 27 is then inserted into the housing with its second end extending externally of external surface 9 of housing 2. Flow indicator member 28 is then mounted to pivot shaft 26 and to the second end of eutectic metal fuse 27. When pivot shaft 26 is placed in locked rotational relationship with flow indicator member 28, spring 16 will remain compressed until failure of eutectic metal 27 occurs. The valve assembly 1 may then be placed into a fuel line where fluid flow through the assembly will remain uninterrupted until the failure temperature of the eutectic metal alloy is reached. It is to be understood that this invention is subject to many modifications without departing from the scope and spirit of the claims recited herein.

What is claimed is:

1. A heat activated fluid flow shut-off valve, comprising:
(a) a housing having an external surface, a longitudinal axis, an upstream end, a downstream end, and an axially extending void for the passage of fluid therethrough;
(b) a pivot shaft carried by said housing intermediate said upstream and downstream ends, said pivot shaft having a vertical axis, a first end and second end, said vertical axis extending laterally of said longitudinal axis where said pivot shaft is so adapted and carried by said housing to permit angular rotation of said pivot shaft with respect to said housing;
(c) a valve seat located within said void of said housing intermediate said upstream and downstream ends;
(d) a piston slidably carried within said housing for axial displacement within said void relative to said longitudinal axis and so dimensioned and proportioned such that upon bearing engagement with said valve seat the flow of said fluid through said void is shut-off;
(e) a flow indicator member removably mountable to said first end of said pivot shaft and so adapted for mounting to said pivot shaft such that said flow indicator member may be mounted in fixed rotational relationship with said pivot shaft;
(f) a eutectic metal fuse associated with said housing and said flow indicator member, said eutectic metal fuse extending at least in part externally of said external surface, and where said eutectic metal fuse is temperature sensitive and upon reaching a pre-determined temperature said eutectic metal fuse will fail thereby permitting said flow indicator member to rotate with respect to said housing;
(g) spring means associated with said piston for urging said piston into bearing engagement with said valve seat where said spring means is responsive to failure of said eutectic metal fuse; and
(h) pivot means associated with said piston and said pivot shaft where said pivot means is responsive to said spring means for rotating said pivot shaft upon failure of said eutectic metal fuse.

2. The heat activated fluid flow shut-off valve recited in claim 1 further comprising a piston rod integrally carried by said piston and a support guide captively held and removably mountable to said housing and in slidable relationship with said piston rod where said spring means is in compressive engagement with said piston and said support guide.

3. The heat activated fluid flow shut-off valve recited in claim 1 where said pivot means comprises an extension arm integrally carried by said piston and extending at least in part through said valve seat for applying a torque to said pivot shaft upon downstream axial displacement of said piston.

4. The heat activated fluid flow valve recited in claim 3 where said pivot shaft has a lateral chord slot for receiving said extension arm such that upon sufficient axial displacement of said extension arm said lateral chord slot and said extension arm will be in axial alignment thereby precluding rotation of said pivot shaft.

5. The heat activated fluid flow shut-off valve recited in claim 2 further having a snap-ring for captively holding said support guide within said void.

6. A heat activated device to stop flow in a fuel line, comprising
(a) a housing having an external surface, a longitudinal axis, an upstream end, a downstream end and an axially extending void therethrough for the passage of fluid;
(b) valve means carried by said housing and positioned in said void for stopping fluid flow;
(c) a flow indicator member carried externally of said external surface of said housing;
(d) flow indicator rotation means associated with said flow indicator member and said valve means for rotating said flow indicator member relative to to said housing;
(e) a eutectic metal fuse associated with said valve means and said flow indicator means and extending at least in part externally of said external surface and into said flow indicator member where said eutectic metal fuse is temperature sensitive and will fail upon reaching a pre-determined temperature whereby said valve means is actuated to stop fluid flow in said fuel line and said flow indicator rotation means rotates said flow indicator member.

7. The heat activated device recited in claim 6 where said valve means comprises a valve seat within said void and located intermediate said upstream and downstream ends and a piston slidably carried within said void and so dimensioned and proportioned such that upon bearing engagement with said valve seat said fluid flow is stopped.

8. The heat activated device recited in claim 7 where said valve means further comprises a spring for biasing said piston into bearing engagement with said valve seat.

9. The heat activated device recited in claim 8 where said flow indicator rotation means comprises a pivot shaft located intermediate said downstream end and said valve seat and an extension arm carried by said piston and extending through said valve seat where said pivot shaft is adapted for rotation with respect to said housing upon axial displacement of said extension arm.

10. The heat activated device recited in claim 9 where said valve means further comprises a support guide captively and removably carried in fixed relationship by said housing in slidable telescopic relationship with said piston where said spring is in compressive bearing engagement with said housing and said support guide such that upon failure of said eutectic metal, said piston is displaced axially downstream into bearing engagement with said valve seat.
